(19) United States
(12) Patent Application Publication
(10) Pub. No.: US 2015/0176790 A1
(43) Pub. Date: Jun. 25, 2015

(54) LIGHTING AND/OR SIGNALLING DEVICE FOR VEHICLES

(71) Applicant: AUTOMOTIVE LIGHTING ITALIA S.p.A. A SOCIO UNICO, Torino (IT)

(72) Inventors: Marco Svettini, Torino (IT); Sara Paroni, Torino (IT)

(21) Appl. No.: 14/577,267

(22) Filed: Dec. 19, 2014

(30) Foreign Application Priority Data
Dec. 20, 2013 (IT) PD2013A000353

(51) Int. Cl. F21S 8/10

(52) U.S. Cl. CPC F21S 48/00; F21W 2101/00

(57) ABSTRACT

Lighting and/or signalling device comprising
a container body having a plurality of containment seats each containment seat housing at least one light source electrically connected to electrical connection means to power the same, and suitable for emitting a beam of light to propagate to the outside of the lighting and/or signalling device,
a lenticular body, positioned so as to close the plurality of containment seats and suitable to receive the beam of light produced by each light source and to propagate it towards the outside of the lighting and/or signalling device, at least in a longitudinal direction of propagation of the beam of light,
wherein the lenticular body, at each containment seat comprises a first lighting portion, used to diffuse a beam of light of a predefined colour, delimited by a first optic filter, having a first colour different from said predefined colour,
each light source being positioned inside the containment seat in a position rearward of the lenticular body, in a longitudinal direction of propagation of the beam of light,
each light source facing a light guide which comprises a light input wall which receives the beam of light produced by the light source, propagates it along a light guide body and emits it from a light output wall, facing the lenticular body so that the beam of light crosses the lenticular body,
wherein between each light source and the light input wall a second optic filter is positioned, having a second colour different from the first colour of the first optic filter so that the beam of light produced by each light source and filtered by the second and by the first optic filter in succession comes out of the lenticular body having said predefined colour,
   wherein the first optic filters of adjacent portions of lenticular body are the same colour so as to prove substantially indistinguishable when the respective light sources are deactivated.

### FIELD OF APPLICATION

The present invention relates to a lighting and/or signalling device for vehicles, such as for example a vehicle light and the like.

### STATE OF THE ART

The term vehicle light is understood to mean indifferently a rear vehicle light or a front vehicle light, the latter also known as a headlight.

As is known, a vehicle light is a lighting and/or signalling device of a vehicle comprising at least one external vehicle light having a lighting and/or signalling function towards the outside of the vehicle such as for example a sidelight, an indicator light, a brake light, a rear fog light, a reverse light, a dipped beam headlight, a main beam headlight and the like.

For the purposes of the present invention however, the term lighting and/or signalling device is taken to mean not just a vehicle light as described above but also further lighting and/or signalling devices, such as map lights and the like.

Consequently, within the sphere of the present invention lighting and/or signalling device for vehicles is taken to mean a lighting and/or signalling device of a vehicle comprising at least one light having a lighting and/or signalling function.

In the description which follows however, reference will be made to a vehicle light without by so doing losing its general application.

The lighting and/or signalling device, in its simplest form comprises a container body, a lenticular body and at least one light source.

The lenticular body is placed so as to close a mouth of the container body so as to form a housing chamber. The light source is arranged inside the housing chamber, which may be directed so as to emit light towards the lenticular body, when powered with electricity.

As is known, vehicle lights must comprise at least one signalling/lighting device which serves for example for the rear and/or lateral sidelight, brake light, indicator light, reverse light functions.

Usually, the lights which must perform these different functions must provide for precise and different colours, imposed by regulations.

### PRESENTATION OF THE INVENTION

The prior solutions thus have the drawback of evidently modifying the aesthetic appearance of the light, i.e. of the lenticular body, even when this is not lit, i.e. when the internal light source is not powered.

In other words, the light has portions of lenticular body having different colours at the portions of light used for example as indicator lights, sidelights, brake lights, reverse lights.

The alternation of portions of lenticular body having different colours also changes considerably the overall aesthetic appearance of the light which, in addition to performing the lighting/signalling function, is often regarded as a highly distinctive design element for the whole vehicle.

In order to limit at least partially the use of portions of lenticular body of different colours and thereby harmonize as much as possible the appearance of the light, it is known of in the lighting field to use “subtractive mixing’ techniques.

In practice a sequences of filters is used, typically two, to emit light in the desired final colour, through a portion of lenticular body the same or not too dissimilar from adjacent portions of lenticular body used for different signalling/lighting functions.

In other words, between the light source and the portion of the lenticular body used for the signalling/lighting function at least one intermediate filter having a different colour from that of the lenticular body is positioned; the light emitted by the light source is thus filtered both by the intermediate filter and by the portion of the lenticular body, and by subtractive mixing, the light of the desired colour is obtained in output from the vehicle light; depending on the final colour to be obtained, a portion of lenticular body having an identical colour or not too dissimilar from adjacent portions of the lenticular body may be used.

As seen, the colours of the lights are obtained through the use of optical filters combined with the light source wherein, for example, the lenticular body can act as a first optical filter facing a second optical filter.

However such optical filters are generally located downstream of an optical system which comprises them, along a vehicle axis oriented towards an outside observer. It follows that said optical filters can generate an undesired colour stimulus, when the light source is turned off.

This way the observer has the perception of the presence of various optical components of the light used for the lighting/signalling functions mentioned such as side lights, brake lights, indicator lights, reverse lights. The overall aesthetics of the vehicle light are thus modified.

The need is thus felt to make a vehicle light which makes it possible to emit lights of different colours in order to perform the various lighting/signalling functions of the light, when it is on, i.e. when the lights are powered, and which, at the same time, does not invalidate the aesthetic appearance of the light when not in use (i.e. lights off).

Such need is satisfied by a lighting and/or signalling device according to claim 1.

Other embodiments of the lighting and/or signalling device according to the invention are described in the subsequent claims.

### DESCRIPTION OF THE DRAWINGS

Further characteristics and advantages of the present invention will be more clearly comprehensible from the description given below of its preferred and non-limiting embodiments, wherein:

FIG. 1 shows a perspective view, in separate parts, of a lighting and/or signalling device according to one embodiment of the present invention;

FIG. 2 shows a front view, in an assembled configuration, of the lighting and/or signalling device in FIG. 1;

FIG. 3 shows a cross-section view of the lighting and/or signalling device in FIG. 1, along the cross-section plane III-III in FIG. 2;

FIG. 4 shows a cross-section view of the lighting and/or signalling device in FIG. 1, along the cross-section plane III-III in FIG. 2, according to a further embodiment of the present invention;

FIG. 5 shows a cross-section view of the enlarged detail V in FIG. 4;

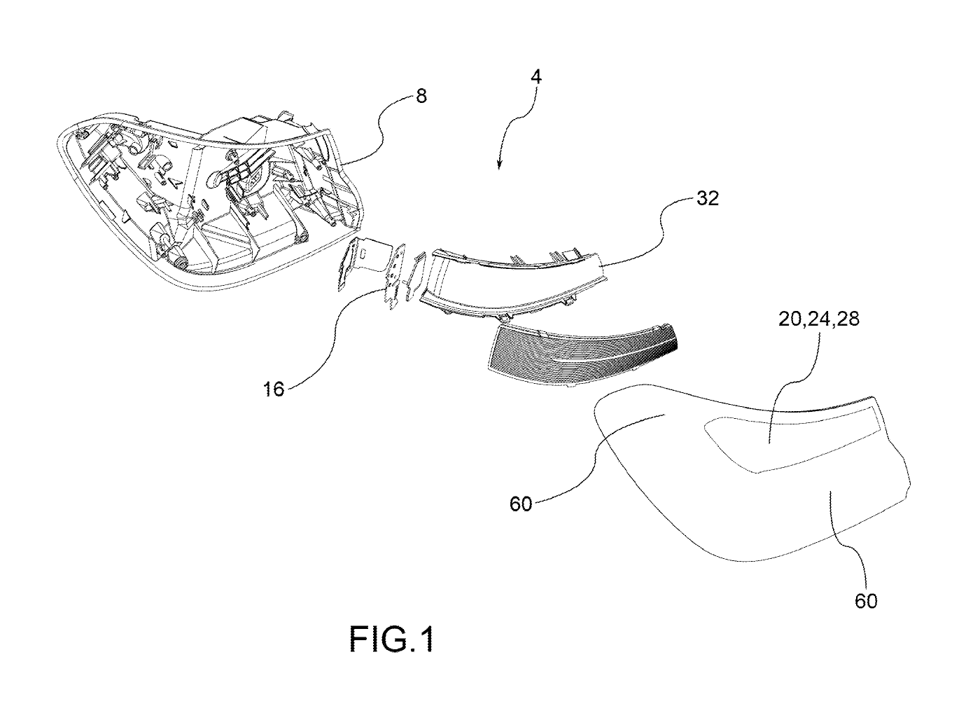

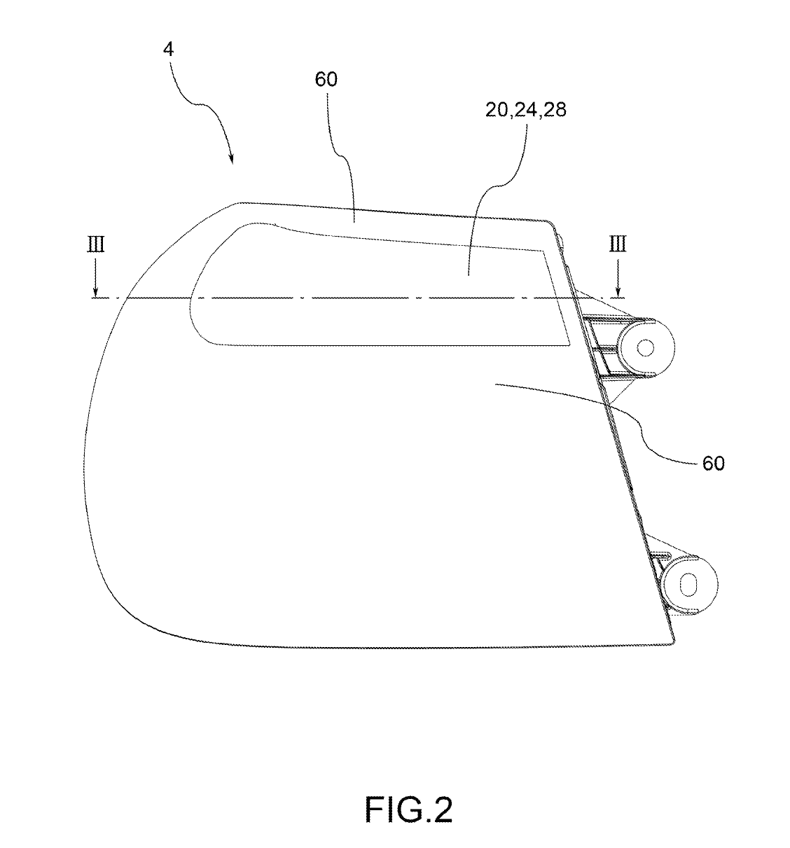

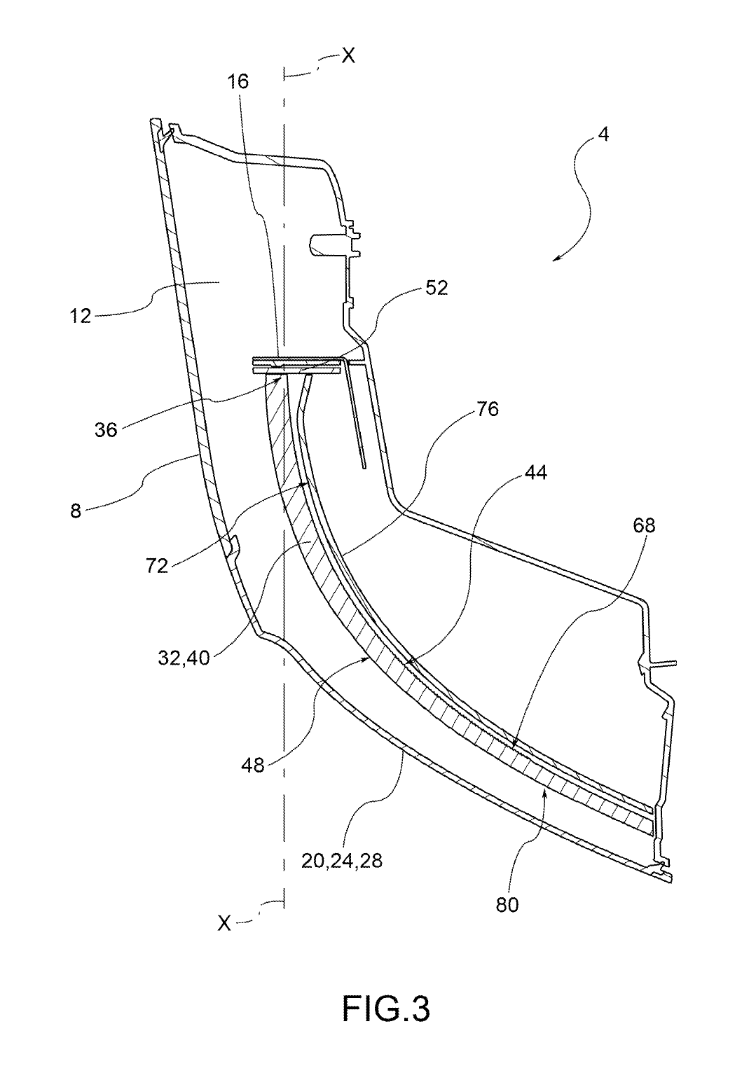

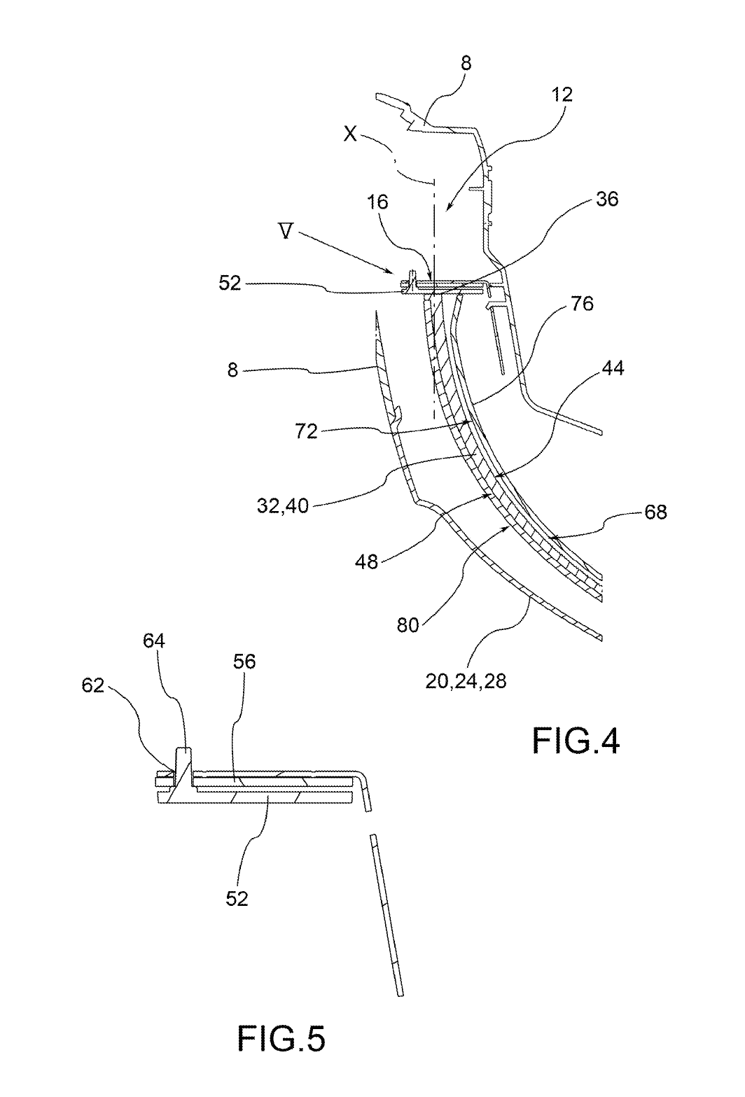

The elements or parts of elements common to the embodiments described below will be indicated using the same reference numerals.

### DETAILED DESCRIPTION

With reference to the aforementioned figures, reference numeral 4 globally denotes a lighting and/or signalling device for vehicles, such as a vehicle light, which the description which follows refers to without by so doing losing its general application.

As mentioned above, the term vehicle light is understood to mean indifferently a rear vehicle light or a front vehicle light, the latter also known as a headlight. As known the vehicle light comprises at least one outer light of the vehicle having a lighting and/or signalling function, such as for example a sidelight, which may be a front, rear or lateral sidelight, an indicator light, a brake light, a rear fog light, a dipped beam headlight, a main beam headlight and the like.

However, it is understood that in the context of the present invention a lighting and/or signalling device for vehicles is generally understood as a lighting and/or signalling device of a vehicle comprising at least one vehicle light having a lighting or signalling function.

Furthermore, the definition of lighting and/or signalling device of the vehicle type should also be understood in the generic sense, comprising a lighting device and/or signalling device suitable to be used on any type of vehicle for locomotion.

The lighting and/or signalling device 4 comprises a container body 8, usually of polymeric material, which allows the attachment of the lighting and/or signalling 4 device to the relative vehicle.

The container body 8 delimits a containment seat 12 which houses at least one light source 16, electrically connected to electrical connection means to power the same, and suitable for emitting a beam of light to propagate to the outside of the lighting and/or signalling device 4. For the purposes of the present invention it is possible to use different types of light sources 16; preferably, the light source is a light source of light emitting diodes (LED).

The lighting and/or signalling device 4 further comprises a lenticular body 20, positioned so as to close the containment seat 12 and suitable to be crossed by the beam of light produced by the light source 16 in such a way that said beam of light may be propagated towards the outside of the lighting and/or signalling device 4, passing through the lenticular body 20, at least in a longitudinal direction X-X of propagation of the beam of light,

The lenticular body 20 is made of at least partially transparent or semi-transparent or translucent material, and may also comprise an opaque portion, so as to allow in any case the crossing of the light beam produced by the light source.

The lighting and/or signalling device 4 further comprises a first lighting portion 24 delimited by a first optic filter 28 having a first colour.

The colour of the light beam in output, determined by the specific function of the lighting and/or signalling device 4, is different from the colour of the first optical filter 28, as better described below.

By way of example, in the case in which one wishes to obtain a reverse light, the predetermined colour for said signalling/lighting function is white, in the case of an indicator light the predetermined colour is orange, in the case of the sidelights, the predetermined colour is red, and so on.

Obviously the same lighting and/or signalling 4 device can fulfil all the aforementioned functions, and will thus be predisposed to be able to emit, at the various portions of the lenticular body, light beams of predetermined different colours, wherein said different portions of lenticular body, in the configuration of light sources turned off, are not distinguishable from the outside, as described below.

According to one embodiment, the light source 16 is positioned inside the containment seat 12 in a position rearward of the lenticular body 20, in a longitudinal direction X-X of propagation of the beam of light.

Diversely from the known solutions, the light source 16 is facing a light guide 32 which comprises a light input wall 36 which receives the beam of light produced by the light source 16, propagates it along a light guide body 40 and emits it from a light output wall 48, facing the lenticular body 20 so that the beam of light crosses the lenticular body 20.

The light output wall 48 is in turn facing the first lighting portion 24 delimited by a first optic filter 28, having a first colour.

Between the light source 16 and the light input wall 36 a second optic filter 52 is positioned having a second colour, different from the first colour of the first optic filter 28 so that the beam of light produced by the light source 16 and filtered by the second and by the first optic filter 52, 28 in succession comes out of the lenticular body 20 having a predefined colour. According to a further embodiment, the lenticular body comprises the first lighting portion 24 provided with the first optical filter 28.

The predetermined colour is obtained by double filtration or subtractive mixing of the light beam produced by the light source 16, through the combined action of the two optical filters 28, 52, separated by a neutral filter element, such as the light guide 32. The light guide 32 thus acts as a separator element of the two optical filters 52, 28 without changing the effect of subtractive synthesis of the two optical filters 52, 28. Thanks to the light guide 32, the second filter 52 is not placed adjacent to the first optical filter 28, as in the prior art, but distant from the latter so as to avoid generating an unwanted colour stimulus with the optical filter 28, in particular along a vehicle axis oriented in the direction of propagation X-X or longitudinal direction towards an outside observer when the light source 16 is turned off.

Only the first optical filter 28 can thus confer the desired colour stimulus along such vehicle axis, when the light source 16 is turned off.

More specifically, the first lighting portion 24 of the lenticular body 20, having a first lighting function, is delimited by a first optic filter 28 having a colour substantially similar or identical to the colour of an adjacent portion 60 of lenticular body 20, having a second different lighting and/or signalling function or cornice function, so that the first optic filter 28 cannot be substantially distinguished, from the outside of the lighting and/or signalling device 4, from the adjacent portion 60 of lenticular body 20. The light guide 32 makes it possible to position the second optical filter 52 in the vicinity of the light source and, thus, in a position hidden from view to an outside observer.

Proceeding in this manner, in the case in which one wishes for example to obtain an indicator light, the first optic filter 28 is a pink colour, the colour of the adjacent portion 60 of lenticular body 20 is red, while the colour of the second optic filter 52 is green and is separated from the first optical filter 28 by the light guide 32 so as to obtain in output from the lenticular body 20 a substantially orange beam of light when the light source 16 is on, and to obtain a lenticular body 20 substantially tending to red, when the light source 16 is off.

Furthermore, it is possible to obtain different combinations of filters in order to obtain lights in output from the lenticular body 20 having different colours.

According to the invention, it is possible to use a lighting and/or signalling device 4 comprising a container body 8 having a plurality of containment seats 12 each containment seat 12 housing at least one light source 16 electrically connected to electrical connection means to power the same, and suitable for emitting a beam of light to propagate to the outside of the lighting and/or signalling device 4.

The lighting and/or signalling device 4 further comprises a lenticular body 20, positioned so as to close the plurality of containment seats 12 and suitable to be crossed by the beam of light produced by each light source 16, so that said beam can be propagated towards the outside of the lighting and/or signalling device 4.

The lenticular body 20, at each containment seat 12 comprises a first lighting portion 24, used to diffuse a beam of light of a predefined colour, delimited by a first optic filter 28, having a first colour different from said predefined colour, each light source 16 being positioned inside the containment seat 12 in a position rearward of the lenticular body 20, in a longitudinal direction X-X.

Each light source 16 faces a light guide 32 which comprises a light input wall 36 which receives the beam of light produced by the light source 16, propagates it along a light guide body 40 and extracts it from the light extraction wall 44, opposite the lenticular body in the direction of propagation X-X, towards the light output wall 48 facing the lenticular body 20 in relation to the direction of propagation X-X.

Between each light source 16 and the light input wall 36 a second optic filter 52 is positioned, having a second colour different from the first colour of the first optic filter 28 so that the beam of light produced by each light source 16 and filtered by the second and by the first optic filter 52, 28 in succession comes out of the lenticular body 20 having said predefined colour, The first optic filters 28 of adjacent portions 60 of lenticular body 20 are the same colour so as to prove substantially indistinguishable when the respective light sources 16 are deactivated. It should be noted that the adjacent portions 60 of the lenticular body 20 may be in one piece or may be separate portions arranged side by side. Usually the lenticular body 20 is made of a single piece; in any case it is possible to make the lenticular body 20 in several adjacent portions 60 arranged side by side so as to close the respective containment seats 12. According to one embodiment, the second optic filter 52 is directly applied to the light input wall 36 of the light guide 32.

It is possible to obtain the second optical filter 52 by means of deposition techniques, in themselves known, such as spattering, CVD, PVD on said light input wall 36.

According to one embodiment, the second optic filter 52 is associated to a power supply and support strip 56 of the light source 16, so as to position itself between the light source 16 and the light input wall 36. In particular, the power supply and support strip 56 is a strip for LEDs provided with at least one hole 62, and the second optical filter 52 comprises a pin 64 coupled to said hole 62; preferably the pin 64 is co-moulded with the second optical filter 52 and is inserted into the hole 62 and subsequently hot riveted, so as to create an undercut to its extraction from said hole.

According to one embodiment, the light extraction wall 44 of the light guide 32 has a plurality of extractor elements 68, which extract the light toward the light output wall 48 facing the lenticular body 20.

For example, said extractor elements 68 comprise extractor prisms shaped so as to extract the light mainly in a longitudinal direction X-X.

According to one embodiment, the lighting and/or signalling device 4 comprises a reflective surface 72 facing the light extraction wall 44 and opposite the lenticular body 20, in relation to the light guide 32, said reflective surface 72 reflecting the beam of light towards the lenticular body 20.

Preferably, the reflective surface 72 is counter-shaped to the light guide 32.

For example, the reflective surface 72 is obtained by means of metallisation or by applying mirrors to a support wall 76, or even by the realisation of a white layer, facing the light extraction wall 44 of the light guide 32.

According to one embodiment, the light output wall 48 may comprise a diffusing surface 80 suitable to evenly distribute the light in output from the light guide 32, for example obtained by satin finishing or embossing. According to one embodiment, the light output wall 48 may comprise a diffusing surface 80 having light diffusing elements, for example made by reliefs, grooves, etchings of said light output wall 48 or semi cylindrical optics.

As may be appreciated from the description, the lighting and/or signalling device according to the invention makes it possible to overcome the drawbacks of the prior art.

Indeed, from outside, the vehicle light according to the present invention has a lenticular body having a predetermined colour, substantially uniform, when the light sources are off, it is not possible from the outside to distinguish the different portions of lenticular body used for the various lighting/signalling functions of the light.

From the outside, the observer has the perception of a lenticular body having a substantially uniform colour, because, as seen, the first optical filter gives a uniform colour relative to the adjacent portions of the lenticular body, as desired, when the light source is turned off, since the second filter can be placed away from the first optical filter through the use of a separator element such as the light guide.

It is therefore possible to select the colour of the first filter so that it is uniform and similar to the colour of the adjacent portions of the lenticular body. Obviously, upon powering of the light sources, the different portions of the lenticular body, thanks to the subtractive mixing technique achieved through the filters, makes it possible to emit light beams of different colours to perform the specific lighting/signalling functions of the light, such as for example the brake lights, sidelights, indicator lights and reverse lights.

It is thus possible to make lenticular bodies in which the various portions of the light, used for the aforementioned lighting/signalling functions are camouflaged or not easily discernible by an outside observer.

This way the overall appearance of the vehicle light, and the vehicle as a whole, is not affected in any way when the light sources are not powered.

A person skilled in the art may make numerous modifications and variations to the lighting and/or signalling devices described above so as to satisfy contingent and specific requirements while remaining within the sphere of protection of the invention as defined by the following claims.

1. Lighting and/or signalling device comprising
a container body having a plurality of containment seats each containment seat housing at least one light source electrically connected to electrical connection means to power the same, and suitable for emitting a beam of light to propagate to the outside of the lighting and/or signalling device,
a lenticular body, positioned so as to close the plurality of containment seats and suitable to receive the beam of light produced by each light source and to propagate it towards the outside of the lighting and/or signalling device, at least in a longitudinal direction of propagation of the beam of light,
wherein the lenticular body, at each containment seat comprises a first lighting portion, used to diffuse a beam of light of a predefined colour, delimited by a first optic filter, having a first colour different from said predefined colour,
each light source being positioned inside the containment seat in a position rearward of the lenticular body, in a longitudinal direction of propagation of the beam of light,
each light source facing a light guide which comprises a light input wall which receives the beam of light produced by the light source, propagates it along a light guide body and emits it from a light output wall, facing the lenticular body so that the beam of light crosses the lenticular body,
wherein between each light source and the light input wall a second optic filter is positioned, having a second colour different from the first colour of the first optic filter so that the beam of light produced by each light source and filtered by the second and by the first optic filter in succession comes out of the lenticular body having said predefined colour,
wherein the first optic filters of adjacent portions of lenticular body are the same colour so as to prove substantially indistinguishable when the respective light sources are deactivated.

2. Lighting and/or signalling device according to claim 1, wherein the lenticular body comprises said first lighting portion fitted with the first optic filter.

3. Lighting and/or signalling device according to claim 1, wherein the second optic filter is directly applied to the light input wall of the light guide.

4. Lighting and/or signalling device according to claim 1, wherein the second optic filter is obtained by deposition techniques such as spattering, CVD, PVD on said light input wall.

5. Lighting and/or signalling device according to claim 1, wherein the second optic filter is associated to a power supply and support strip of the light source, so as to position itself between the light source and the light input wall of the light guide.

6. Lighting and/or signalling device according to claim 1, wherein the light guide comprises a light extraction wall fitted with a plurality of light extraction elements, which extract the light towards the light output wall facing the lenticular body.

7. Lighting and/or signalling device according to claim 6, wherein said extractor elements comprise extractor prisms shaped so as to extract the light mainly in a longitudinal direction.

8. Lighting and/or signalling device according to claim 1, wherein the lighting and/or signalling device comprises a reflective surface facing the light extraction wall and opposite the lenticular body, in relation to the light guide, said reflective surface reflecting the beam of light towards the lenticular body.

9. Lighting and/or signalling device according to claim 8, wherein the reflective surface is counter-shaped to the light guide.

10. Lighting and/or signalling device according to claim 8, wherein the reflective surface is obtained by means of metallisation or by applying mirrors to a support wall, or by the realisation of a white layer, facing the light extraction wall of the light guide.

11. Lighting and/or signalling device according to claim 1, wherein the light output wall comprises a diffuser surface suitable to evenly diffuse the light in output from the light guide.

12. Lighting and/or signalling device according to claim 1, wherein the light output wall comprises a diffuser surface suitable to evenly diffuse the light in output from the light guide.

13. Lighting and/or signalling device according to claim 12, wherein the diffuser surface of the light output wall comprises light diffusion elements such as glazing, embossing.

14. Lighting and/or signalling device according to claim 12, wherein said diffuser surface of the light output wall comprises light diffusion elements such as projections, grooves, incisions of said light output wall or semi-cylindrical optics.

15. Lighting and/or signalling device according to claim 1, wherein the first lighting portion of the lenticular body, having a first lighting function, is delimited by a first optic filter having a colour substantially similar or identical to the colour of an adjacent portion of lenticular body, having a second different lighting and/or signalling function, so that the first optic filter cannot be substantially distinguished, from the outside of the lighting and/or signalling device, from the adjacent portion of lenticular body.

16. Lighting and/or signalling device according to claim 1, wherein the first optic filter is a pink colour, the colour of the adjacent portion of lenticular body is red, the colour of the second optic filter is green so as to obtain in output from the lenticular body a substantially orange beam of light when the light source is on, and to obtain a lenticular body substantially tending to red, when the light source is off.
